(19) United States
(12) Patent Application Publication
(10) Pub. No.: US 2019/0289811 A1
(43) Pub. Date: Sep. 26, 2019

(54) WASTE SCOOPER

(71) Applicant: Doskocil Manufacturing Company, Inc., Arlington, TX (US)

(72) Inventors: David VENESS, Fort Worth, TX (US); John ZIVICH, Eastlake, OH (US)

(21) Appl. No.: 16/357,598

(22) Filed: Mar. 19, 2019

Related U.S. Application Data
(60) Provisional application No. 62/645,494, filed on Mar. 20, 2018.

(51) Int. Cl. A01K 1/01

(52) U.S. Cl. CPC A01K 1/0114

(57) ABSTRACT

A waste scooper includes a handle portion and a scoop member. The scoop member has a front edge, a rear wall and a plurality of tines. The plurality tines are spaced such that a distance between each tine of the plurality of tines and each adjacent tine of the plurality tines is the same, and the distance is consistent between each tine of the plurality of tines and each adjacent tine of the plurality tines from the front edge to the rear wall.

### CROSS-REFERENCE TO RELATED APPLICATION

This application claims benefit to U.S. Provisional Application No. 62/645,494, filed Mar. 20, 2018, the contents of which are hereby incorporated herein by reference.

### BACKGROUND

### Technical Field

This invention relates generally to pet supplies. More particularly this invention relates to pet waste scoopers. Specifically, the invention is directed to a scoop assembly for removing clumped waste material from pet litter boxes or from surfaces.

### Background Information

Many animals, such as cats, are kept indoors and the pets therefore have to utilize litter boxes. Litter boxes are typically filled with specially designed litter materials that form clumps around urine and feces. These litter boxes need to be cleared of pet waste on a regular basis to prevent unpleasant odors. The homeowner generally removes the pet waste clumps from the litter box to keep the home odor free and so that the cat will continue to use the litter box rather than go elsewhere.

Since it is undesirable to directly handle the pet waste clumps in litter boxes or the pet waste in grass or on other surfaces, a variety of pet letter scoops have been developed. For example, U.S. Pat. No. 5,580,111 (Bohn) discloses a scoop for animal waste. The scoop defines a plurality of apertures in a bottom wall thereof and through which unsoiled pet litter will drop back into a litter box. Alternatively, the bottom wall may be formed into a plurality of tines or fingers which are separated from each other by apertures. A collection container (i.e., a bag) is engageable with one end of a funnel on the scoop. The scoop is moved into a substantially vertical position to cause captured waste to slide down the funnel and into the bag. The weight of the pet waste causes the bag to hang downwardly from the scoop and may interfere with lifting additional pet waste from a litter box. A tongue is therefore provided on the scoop to cause the bag to be held a distance away from the scoop end of the device. Once all the waste is removed from the litter box, the bag is detached from the scoop and is disposed of. One of the problems with this device is that the user has to hold the funnel portion of the device with one hand and hold the bag in engagement with the funnel portion with the other hand when the device is being used. If the user's second hand slips during the motion where the scoop is moved to the vertical, the bag could separate from the funnel causing the waste to miss the bag and drop onto some other surface.

### SUMMARY

In view of the state of the known technology and in accordance with a first aspect of the present disclosure, a waste scooper is described and shown that includes a handle portion and a scoop member. The scoop member has a front edge, a rear wall and a plurality of tines. The plurality tines are spaced such that a distance between each tine of the plurality of tines and each adjacent tine of the plurality tines is the same, and the distance is consistent between each tine of the plurality of tines and each adjacent tine of the plurality tines from the front edge to the rear wall.

### BRIEF DESCRIPTION OF THE DRAWINGS

The figures illustrate various views of the embodiments of the present invention.

FIG. 1 is a top rear perspective view of a waste scooper assembly according to an embodiment of the present invention;

FIG. 2 is a top front perspective view of the waste scooper assembly of FIG. 1;

FIG. 3 is a top plan view of the waste scooper assembly of FIG. 1;

FIG. 4 is a side elevational view of the waste scooper assembly of FIG. 1;

FIG. 5 is a front view of the waste scooper assembly of FIG. 1;

FIG. 6 is an enlarged view of the front end of the waste scooper assembly of FIG. 1;

FIG. 7 is a cross section view taken along lines 7-7 in FIG. 1; and

FIG. 8 is a schematic view of the operation of the waste scooper assembly of FIG. 1.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

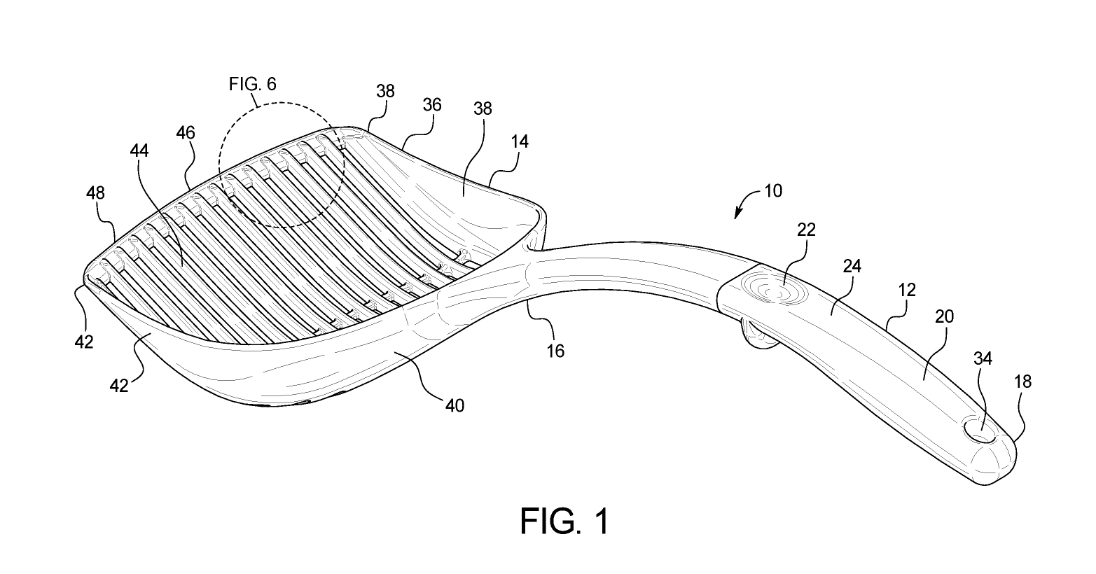

Referring initially to FIG. 1, a waste scooper assembly 10 is illustrated in accordance with a first embodiment. The waste scooper assembly 10 includes a handle 12 and a scoop member 14. In one embodiment, the waste scooper assembly 10 is a unitary plastic molded device; however, the waste scooper assembly 10 can be formed from any suitable material in any suitable manner.

As shown in FIGS. 1-4, the handle 12 has a proximal end 16 at which the handle 12 extends upwardly and outwardly from the scoop member 14, and a distal end 18, at which a user grips the handle 12. The handle 12 is shown as being an integral part of the scoop member 14, but it will be understood that the handle 12 may, instead, be a separate component that is selectively detachably engaged from the scoop member 14.

Furthermore, the handle 12 may itself be a single unitary component or the handle 12 may be comprised of two or more individual components that are secured together in a suitable manner to form the handle. Additionally, the handle 12 or a portion of the handle 12 can include a gripping surface 20 or texturing at or adjacent to the distal end 18 to aid a user in holding on to the handle 12. The gripping surface 20 can be rubber or other material that improves gripping friction or gripping comfort. Moreover, the gripping surface 20 can include a texturing that improves gripping friction or gripping comfort, if desired.

As can be understood, the gripping surface 20 can be a separate rubbed (or other material) member that is added onto the distal end 18 of the handle 12. In such an embodiment, the gripping surface can be held on the handle with an interference fit, glue, other adhesive or in any suitable manner. Moreover, the distal end 18 of the handle 12 can include a recess or other configuration in which the gripping surface 20 can be disposed to facilitate holding of the gripping surface 20 or to improve aesthetics. Alternatively, the gripping member 20 can be a unitary portion of the distal end 18 of the handle 12. That is, the gripping portion 20 can merely be a textured or smooth portion of the handle that is formed during the molding process or any other suitable process.

The handle 12 is further ergonomically designed so that the handle 12 has a comfortable angle α for a user to hold and manipulate and so that the handle 12 is easy to grip. Preferably angle α is between about 150 degrees and 160 degrees, but angle α can be any suitable angle. As can be understood, angle α of the handle 12 can be formed by a varying curvature in the handle that reduces wrist stress at the proximal end 16 extending from the scoop member 14.

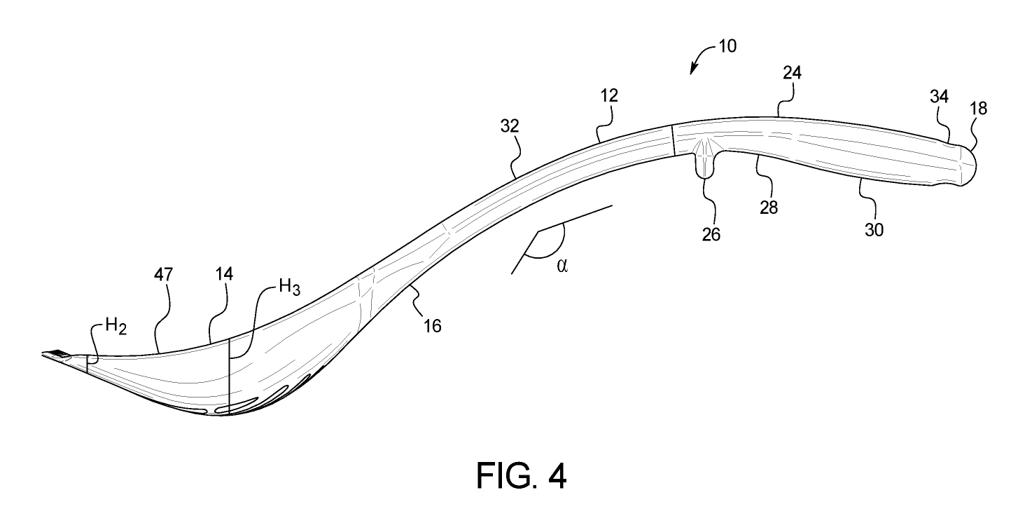

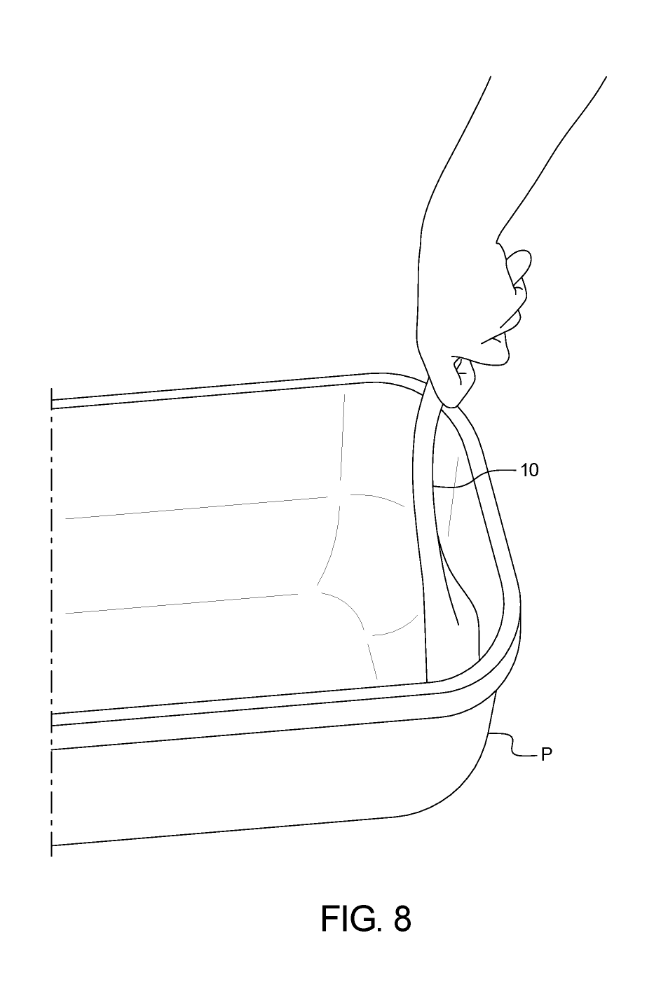

As shown in FIG. 4, in one embodiment, the handle 12 curvature is “flattened” at or adjacent to the scoop member 14. However, the curvature is increased or is significant toward the distal end 18 end of the handle 12. It has been determined that more curve adjacent the scoop member 14 can increase wrist stress. Improved ergonomics are achieved by flattening the curvature of the handle 12 at the area adjacent to or at the proximal end 16 and increasing the curvature along the handle 12 in a direction toward the distal end 18 disposed away from the scoop member 14. Moreover, this handle 12 structure improves pan P accessibility in all areas of the pan P. See for example, FIG. 8.

The handle 12 includes a first or upper stop 22 on an upper surface 24 and a second or lower stop 26 of a lower surface 28. The stops 22 and 24 are strategically positioned for the thumb and the forefinger, respectively, of a user. The handle 12 can also include subtle curves along the length thereof that improves hold and handling comfort. That is, as shown in FIG. 4, the handle 12 can be thicker at a first portion 30 adjacent the distal end 18 than a second portion 32 disposed closer to the proximal end 16. Furthermore, the handle 12 can include an opening 34 adjacent the distal end 18.

Thus, the handle 12 is designed to be formed fit for the user's hand. The stop 26 on the lower surface 28 for the fore finger of the user can be a protrusion or a “bridge” that stops the hand from moving further up the handle 12 in the direction of the scoop member 14. The first or upper stop 22 can be a thumb stop, and can be a depression or recess in the upper surface 24 of the handle 12 to improve gripping.

It should be understood that the exact configuration of the handle 12 is not limited to the specific design shown in the attached figures but any ergonomically shaped handle.

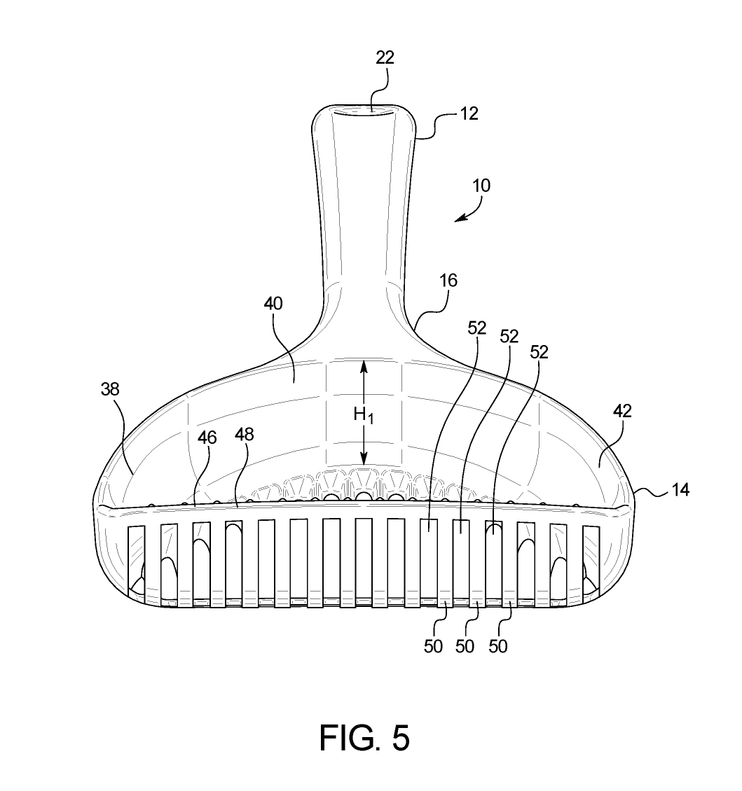

As shown in FIGS. 1-6, the scoop member 14 includes a frame 36 which at least a portion of which may be generally rectangular, although other shapes are possible. In one embodiment, the frame 36 of the scoop member 14 can detachably engage to the proximal end 16 of the handle 12. The frame 36 includes a first wall 38, a second wall 40, and a third wall 42 that extend upwardly from and generally perpendicular from the bottom portion 44 of the scope member 14.

The walls 38, 40, 42 are generally unitary to form a U-shaped or horseshoe shaped configuration when viewed from above. The second wall 40 is arcuate and is disposed between the first wall 38 and third wall 42. The first wall 38 and third wall 42 are generally parallel to each other and have a proximal end 38a and 42a adjacent the second wall and a distal end 38b and 42b adjacent front end 46.

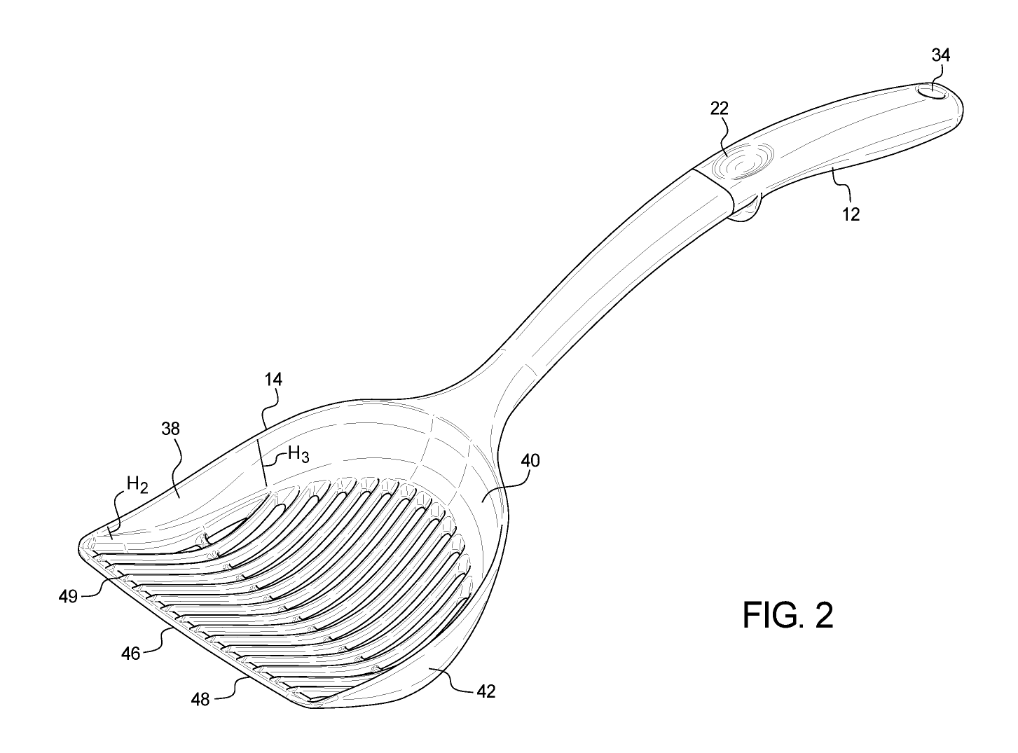

As shown in FIGS. 2 and 4, the first wall 38 and third wall 42 have a first height H₁ adjacent the second wall 40 and a second height H₂ adjacent the front end 46. In one embodiment, the height H₁ is greater than the height H₂ and the height H₃ is greater than the height H₁. Thus, the first wall 38 and third wall 42 appear to increase in height when moving away from the wall 40, and then reduce in height as they approach the front end 46. This change in height can it least partially be caused by the first wall 38 and third wall 42 having an upper edge 47 that is arcuate, as shown in FIG. 4.

All of the walls 38, 40, 42 can be integrally formed with each other to form a unitary member. The walls 38, 40, 42 bound and define an opening 49 between the first wall 38 and the third wall 42. The handle 12 is coupled to the second wall 40. Preferably, the handle 12 is integrally molded to the second wall 40, but the handle 12 can be coupled to the second wall 40 in any suitable manner. It will be understood that while walls 38, 40, 42 are illustrated herein as being disposed generally at right angles to the bottom portion 44, they may also flare slightly outwardly away from bottom portion 44 when the scoop member 14 is viewed from a front end 46, or in any other manner.

The opening 49 between the first wall 38 and the third wall 42 of the scoop member 14 defines the outer rim or edge 48 at the front end 46. The edge 48 is configured in an arcuate manner (or rounded) to facilitate the removal of clumped litter. Moreover, the edge can terminate in an angled point or wedge. This configuration enables the clump of litter to be easily removed in a single piece.

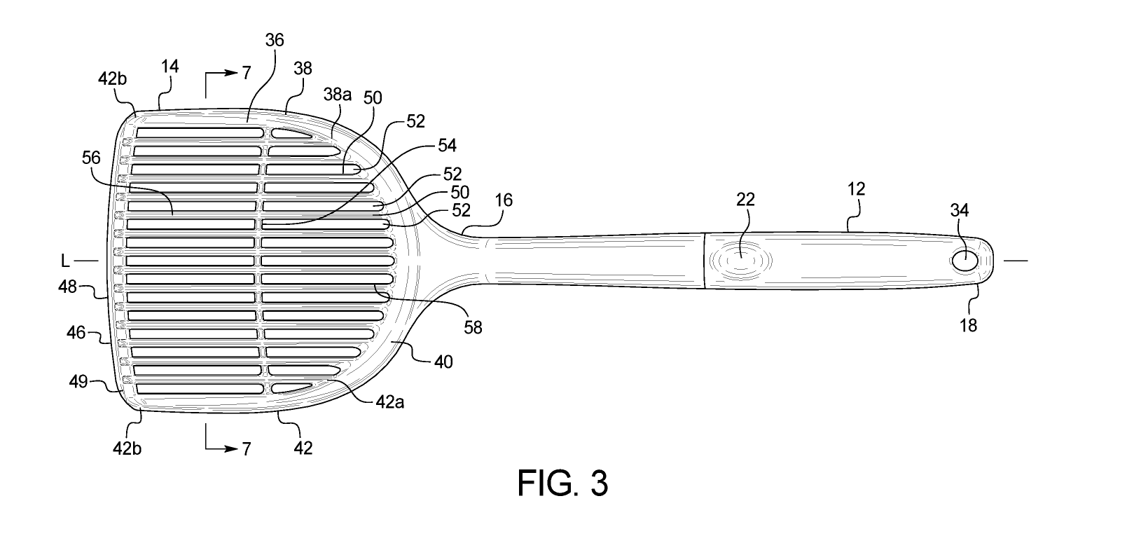

As shown FIGS. 3-7, the bottom portion 44 of the scoop member 14 includes a plurality of tines 50 and can be integrally or unitary molded with the walls 38, 40 and 42 of the scope member. In one embodiment, the bottom portion 44 has an arcuate or arced configuration. The arced configuration of the bottom portion 44 can be more pronounced than the arc of the upper edge 47 of the first and third walls 38 and 42. This curvature of the bottom portion 44, along with the arc of the upper edge 47 forms the first height H₁ adjacent the handle 12, a second height H₂ adjacent the front end 46, and the third height H₃ in the middle. As stated above, the third height H₃ can the greatest or largest the second height H₂ is the least and the first height H₁ can be in between the second height H₂ and the third height H₃. This configuration results in the scoop member 14 that forms a sufficiently deep holding area, while maintaining the proper ergonomic construction and improves ease of scooping.

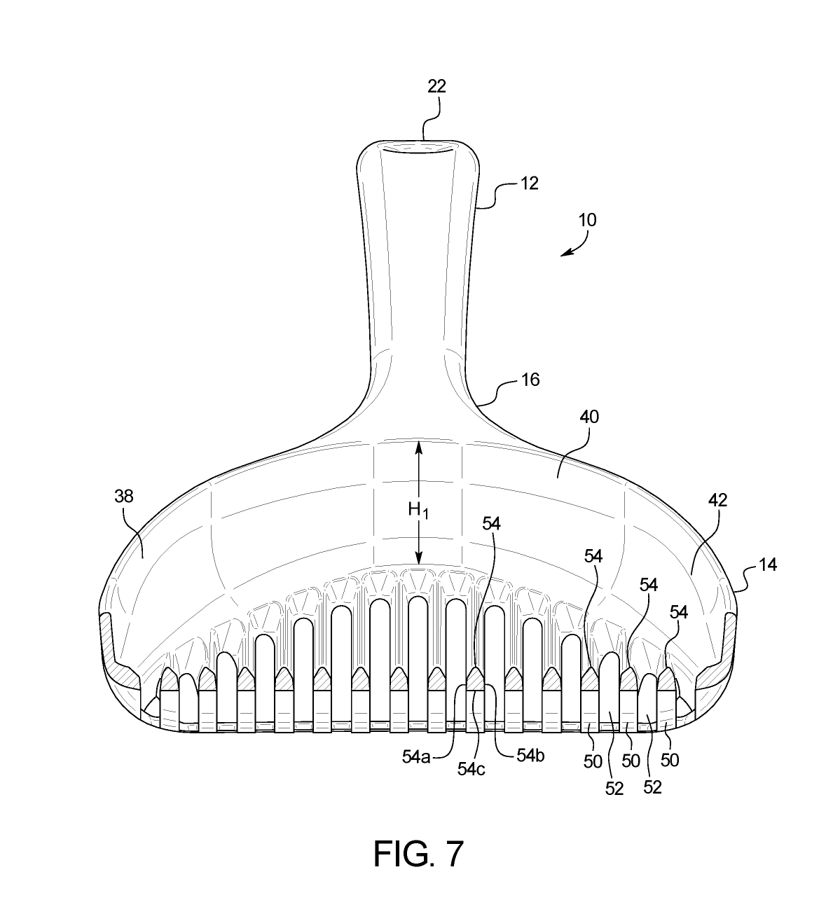

The tines can be separated from each other by a plurality of apertures 52. The apertures 52 are configured so that un-clumped and uncontaminated pet litter is able to be separated from clumped and contaminated pet litter and be subsequently dropped through the apertures 52 and back into a litter pan P. This embodiment includes a “flow thru” rib technology. That is, in this embodiment, each tine 50 can be a rib with a curved upper surface 54, such that the upper surface 54 as no flat portions. The curved upper surface 54 extends to a first side surface 54a and a second side surface 54b (see FIG. 7). A bottom flat surface 54c extends between the first side surface 54a and the second side surface 54b. This structure eliminates side to side motion, so that the un-clumped litter easily falls through the apertures 52, along the flat or straight first and second side surfaces 54a and 54b. leaving only the clumped portions. Moreover, the flat bottom surface 54c enables the bottom portion 44 to slide along the bottom of the pan P and easily scoop litter.

Additionally, each of the tines 50 can be disposed to be parallel and evenly spaced from each other tine 50. The tines 50 preferably extend from the from the front edge 48 to the second wall 40. As shown in FIGS. 1, 3 and 6, the from edge 48 includes a predetermined thickness to which the tines 50 attach. This, predetermined thickness acts a front support bar or structure to not only support the tines 50, but also reinforce the front 56 of the scoop member 14. Accordingly, when scooping litter, the reinforcement will prevent possible failure of the scoop member and enable ease of scooping litter.

The tines 50 preferably extend generally parallel to the longitudinal direction L of the scooper member 14. Thus, the tines 50 are spaced such that a distance between each adjacent tine 50 is the same, and the distance is consistent between each adjacent tine 50 from the front edge 48 to the second (rear) wall 40.

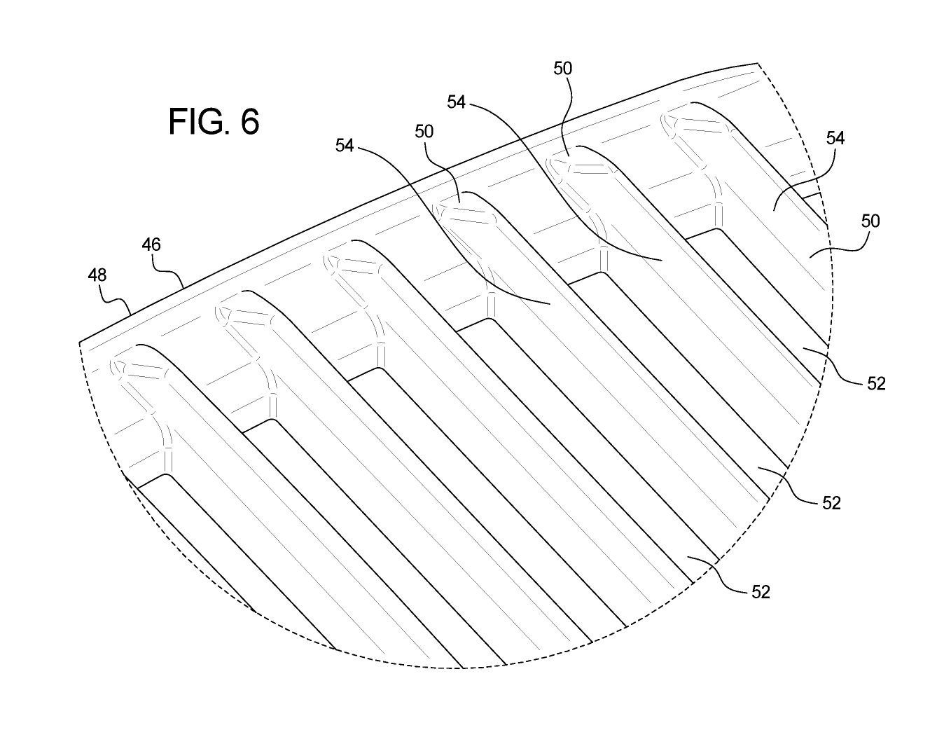

As shown in FIGS. 2 and 6, the tines 50 can be raised relative to the edge 48 or front 46. Such a configuration enables the unclumped litter to be quickly sifted and separated.

In one embodiment, the tines 50 can extend generally transverse or perpendicular to the front edge 48. However, it is noted that the tines can extend in any suitable direction or manner. In one embodiment, the apertures 52 and tines 50 extend at least partially upwardly on the second wall 40. In this embodiment, the bottom portion 44 can include a cross members or bar 54 that connects the tines 50 and extends transverse (e.g., perpendicular) to the direction of the tines 50. In some embodiments that bottom portion 44 can include a plurality of cross members or bars 54, if desired. The cross bar 54 can improve the structural integrity of the tines 50. That is, the cross bar 54 will reduce the transverse movement or flexing of the tines 50.

Thus, as shown in FIG. 3, the cross bar 54 can divide the tines 50 into a front or first tine area 56 and a rear or second tine area 58. The distance between the tines 50 in the front area 56 is the same as the distance between the tines 50 in the second area 58.

As shown in FIG. 8, the waste scooper assembly 10 enables the user to reduce wrist curvature and more effectively reach the interior corners and edges of the pan P. One can understand that the present has less curvature for a more natural feel and improved ergonomics achieved by the handle configuration. Thus, the structure of the waste scooper assembly 10 improves gripping of the handle 10 and reduces stress on the user's wrist, resulting in a more enjoyable easier to use waste scooper assembly 10.

In particular, the user can access corners of the pan P as shown in Figure and move the edge 48 of the scoop member 14 along the bottom of the pan P. As the edge 48 contacts the litter, unclumped litter will be separated and pass through the apertures 52, passing along the side surfaces 54a and 54b. Since the tines 50 are disposed so as to be raised relative to the edge 48 or front 46, the unclumped litter immediately begins to separate and pass between adjacent tines. This configuration enables the litter to easily slide through the apertures 52 without the user needed to actively sift (i.e., move the scoop member 14 from side to side. Thus, there is less risk of injury during scooping.

The unclumped litter will be easily separated by the curved upper surfaces 54 of the tines 50. In other words, the curved upper surfaces 54 enable easy of movement of the unclumped litter to pour through the apertures 52, avoiding unnecessary clogging and capture of unclumped litter.

On the contrary, the clumped litter will be captured by the wedged configuration of the front edge 48 and be raised onto the curved upper surfaces 54 of the tines 50. Since the clumped litter is generally thicker than the width of the apertures 52 between the tines 50, the clumped litter will be captured or held by the tines 50 such that it does not pass through the apertures 52. Based on the design and configured of the scoop member 14, the clumped litter will be held in the scoop member 14. In other words, since the scoop member has a curved bottom portion 44, along with an arced upper edge 47 forming the first height H₁, the second height H₂, and the third height, the scoop member 14 has a significant holding area and cradles the clumped litter, avoiding possible overflow or dropping of the clumped litter. Such a configuration is an improvement over conventional scoops, reducing possible wrist injury and improving the ability to scoop litter.

In understanding the scope of the present invention, the terms “part,” “section,” “portion,” “member” or “element” when used in the singular can have the dual meaning of a single part or a plurality of parts unless otherwise stated.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A waste scooper comprising:
a handle portion; and
a scoop member having a front edge, a rear wall and a plurality of tines, the plurality tines being spaced such that a distance between each tine of the plurality of tines and each adjacent tine of the plurality tines is the same, and the distance is consistent between each tine of the plurality of tines and each adjacent tine of the plurality tines from the front edge to the rear wall.

2. The waste scooper of claim 1, wherein
the front edge is curved so as to facilitate waste removal.

3. The waste scooper of claim 1, wherein
the handle includes a prostration on a surface thereof, the protrusion configured to contact a user finger during use.

4. The waste scooper of claim 1, wherein
each of the plurality of tines has a rounded top surface.

5. The waste scooper of claim 1, wherein
each of the plurality of tines extends into the real wall.

6. The waste scooper of claim 1, wherein
an upper surface of the handle includes a recess configured to improve gripping.

7. The waste scooper of claim 1, wherein
a bar connecting the plurality of tines.

8. The waste scooper of claim 7, wherein
the bar extends transverse to a direction of the plurality of tines.

9. The waste scooper of claim 7, wherein
the bar divide the tines into a first tine area and a second tine area.

10. The waste scooper of claim 1, wherein
the plurality of tines are raised relative to the front edge.

11. The waste scooper of claim 1, wherein
each of the plurality tines is arcuate.

12. The waste scooper of claim 1, wherein
the rear wall is curved.

13. The waste scooper of claim 1, wherein
the scoop member has a first height adjacent the handle and a second height in a middle thereof, the second height being greater than the first height.

14. The waste scooper of claim 13, wherein
the scoop member has and a third height adjacent the front edge, the third height being less than the first height.
